(19) United States
(12) Patent Application Publication
(10) Pub. No.: US 2021/0133655 A1
(43) Pub. Date: May 6, 2021

(54) TRANSPORTATION PLAN GENERATION APPARATUS AND TRANSPORTATION PLAN GENERATION METHOD

(71) Applicant: HITACHI TRANSPORT SYSTEM, LTD., Tokyo (JP)

(72) Inventors: Issei SUEMITSU, Tokyo (JP); Kei UTSUGI, Tokyo (JP); Junko HOSODA, Tokyo (JP); Naoko KISHIKAWA, Tokyo (JP); Yoshihito SHIMAZU, Tokyo (JP); Takahiro NISHIKAWA, Tokyo (JP); Akira KOYAMA, Tokyo (JP)

(73) Assignee: HITACHI TRANSPORT SYSTEM, LTD., Tokyo (JP)

(21) Appl. No.: 17/081,321

(22) Filed: Oct. 27, 2020

(30) Foreign Application Priority Data
Oct. 31, 2019 (JP) 2019-198578

(51) Int. Cl. G06Q 10/06; G06Q 10/08; G06Q 30/02; G06Q 40/00; G06Q 10/10; G06N 20/00

(52) U.S. Cl. CPC G06Q 10/06315; G06Q 10/0838; G06Q 30/0201; G06N 20/00; G06Q 40/12; G06Q 10/109; G06Q 10/087; G06Q 30/0202

(57) ABSTRACT

A transportation plan generation apparatus can access transported item count information that stores a transportation date, a transported item, and a transported item count, transported item information that stores the transported item and a volume, and transportation fee information that stores a transportation means, a load volume, a fee for each period. The apparatus executes: detecting a first period, among a plurality of periods, during which the transportation volume for each period based on the transported item count and the volume exceeds a threshold; identifying second periods that are prior to the first period, and that don't correspond to the first period; determining a given second period during which the fee for the transportation means is less expensive than for the first period, among the second periods, to be a period to which a portion of the transportation volume of the first period is reallocated; and outputting a determination result.

### CLAIM OF PRIORITY

The present application claims priority from Japanese patent application JP 2019-198578 filed on Oct. 31, 2019, the content of which is hereby incorporated by reference into this application.

### BACKGROUND

The present invention relates to a transportation plan generation apparatus that generates a transportation plan and a transportation plan generation method.

JP 2008-77427 A discloses a technique for supporting a proposal for procurement of products for which a shortage is anticipated. In the technique disclosed in JP 2008-77427 A, if a correction to increase production quantity per unit period is desired for a production plan stored in a production plan database when delivery of a product by a typical distribution route would not occur on time even if the product were ordered on short notice, an alternative distribution route search means searches a physical distribution information database for a product type for which a shortage is anticipated and an alternative distribution route by which a shortage would not occur over the unit period, and outputs an alternative distribution route that enables the desired correction to the production plan.

In recent years, there has been a shortage in the number of trucks as well as skyrocketing transportation costs throughout Japan. Thus, in supplying inventory to warehouses, shortages resulting from insufficient transport trucks and an increase in transportation cost have become an issue for customers. For example, in the case of a physical distribution company that rents trucks by contract from a third party, the transport truck unit cost and the number of trucks available for use change depending on the contract period. During busy periods, there is an increase in inventory to be supplied to warehouses while the unit cost of trucks also increases as a result of competition with other physical distribution companies over trucks. One method to deal with this situation is to front-load the transportation of inventory that would otherwise be conducted during the busy period to the off season when the unit cost of transport trucks is low, thereby cutting transportation cost. However, according to JP 2008-77427 A, the unit cost of transport trucks is assumed to be constant, and thus, it is not possible to reduce transportation cost.

### SUMMARY

An object of the present invention is to reduce transport cost.

An aspect of the invention disclosed in this application is a transportation plan generation apparatus, comprising: a processor configured to execute a program; and a storage device configured to store the program, wherein the processor can access transported item count information that stores a transportation date, a transported item, and a transported item count in association with each other, transported item information that stores the transported item and a volume in association with each other, and transportation fee information that stores a transportation means, a load volume, a fee for each period in association with each other, and wherein the processor is configured to execute: a detection process of detecting a first period, among a plurality of periods, during which the transportation volume for each period based on the transported item count and the volume exceeds a threshold; an identification process of identifying second periods that are prior to the first period detected by the detection process, and that do not correspond to the first period; a determination process of determining a given second period during which the fee for the transportation means is less expensive than for the first period, among the second periods identified in the identification process, to be a period to which a portion of the transportation volume of the first period is reallocated; and an output process of outputting a determination result from the determination process.

According to a representative embodiment of the present invention, it is possible to reduce transportation cost. Other objects, configurations, and effects than those described above are clarified by the following description of an embodiment.

### BRIEF DESCRIPTION OF THE DRAWINGS

FIG. 1 is a descriptive drawing showing a demand front-loading example.

FIG. 2 is a block diagram for showing a hardware configuration example of the transportation plan generation apparatus.

FIG. 3 is a block diagram showing a functional configuration example of the transportation plan generation apparatus.

FIG. 4 is a descriptive drawing showing one example of the product information DB.

FIG. 5 is a descriptive drawing showing one example of the transported item count information DB.

FIG. 6 is a descriptive drawing showing one example of the storage fee information DB.

FIG. 7 is a descriptive drawing showing one example of the transportation fee information DB.

FIG. 8 is a descriptive drawing showing one example of the inter-base information DB.

FIG. 9 is a descriptive drawing showing one example of the transportation calendar.

FIG. 10 is a descriptive drawing showing a calculation example for the front-loading priority by the calculation unit.

FIG. 11 is a descriptive drawing showing a determination example for the front-loaded product and the front-load period, and a data update example.

FIG. 12 is a flowchart showing an example of transportation plan generation process steps by the transportation plan generation apparatus.

FIG. 13 is a descriptive drawing showing item-based transportation plan data.

FIG. 14 is a descriptive drawing showing inter-base transportation plan data.

FIG. 15 is a descriptive drawing showing inventory transition data.

FIG. 16 is a descriptive drawing showing cost breakdown data.

FIG. 17 is a graph indicating the transition in the in-use truck count.

FIG. 18 is a block diagram showing a functional configuration example of the transportation plan generation apparatus according to Embodiment 2.

FIG. 19 is a descriptive view showing an example of the performance data.

FIG. 20 is a descriptive view showing an example of the prediction data.

FIG. 21 is a descriptive view showing an example of a prediction result.

FIG. 22 is a descriptive drawing showing an evaluation example value loss cost according to Embodiment 3.

### DETAILED DESCRIPTION OF THE EMBODIMENT

### Embodiment 1

<Demand Front-Loading Example>

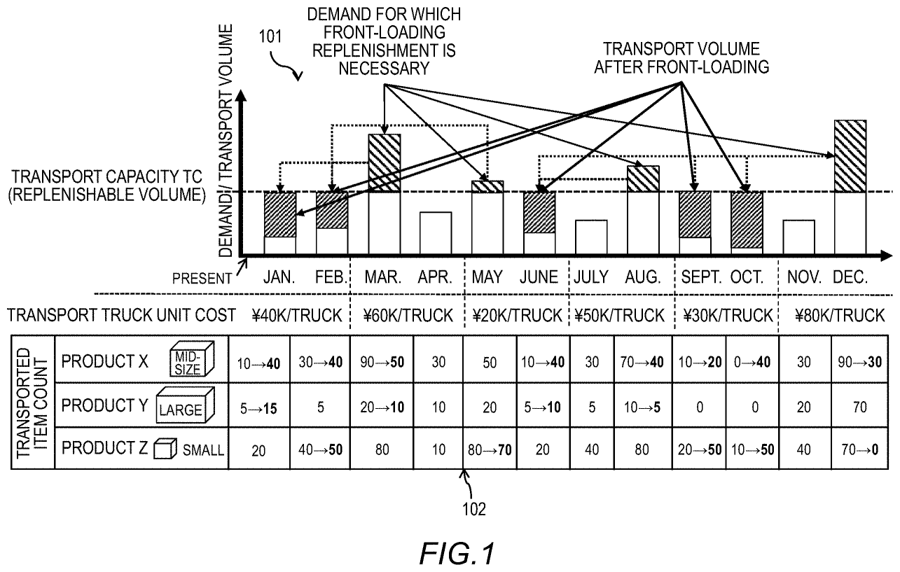

FIG. 1 is a descriptive drawing showing a demand front-loading example. Front-loading signifies shifting excess demand, among the demand in a first period, that exceeds the upper limit for the transportable demand, to a second period prior to the first period. The demand during the second period after the shift also cannot exceed the upper limit for transportable demand.

Graph 101 is a bar graph indicating the demand (prediction value) of products for each month. The horizontal axis indicates the month (January to December) and the vertical axis indicates the demand/transportation volume. The demand/transportation volume is a prediction value or planned value for the products for which transportation by a physical distribution company, which is the transportation source, is demanded. Hereafter, the demand/transportation volume is sometimes referred to as “demand,” “transportation volume,” or “transportation capability.” A transport capacity TC is the upper limit for transportable demand for each month. The transport capacity TC may be fixed value for the entire period (January to December) or may be a fluctuating value that fluctuates across months, but in either case, the value is set in advance. In this example, the transport capacity TC is a fixed value.

A transport truck unit cost is a rental cost for one instance of transportation by one truck, which is an example of a transportation means. The transport truck unit cost corresponds to the horizontal axis of the graph 101. In this example, the transport truck unit cost changes across the year, being ¥40K/truck per day in January and February, ¥60K/truck per day in March and April, ¥20K/truck per day in May and June, ¥50K/truck per day in July and August, ¥30K/truck per day in September and October, and ¥80K/truck per day in November and December, and during the busy period where demand exceeds the transport capacity TC, the transport truck unit cost is greater than during the off season.

The table 102 shows the transported item count for products X, Y, and Z for each month. The transported item count of table 102 corresponds to the horizontal axis of the graph 101. For example, the transported item count for product X in January was 10, but became 40 as a result of front-loading. In table 102, the volume of the products is set such that Y>X>Z.

In graph 101, March, May, August, and December, during which demand exceeds the transport capacity TC are the front-loading periods where front-loading replenishment is necessary, and the demand during the front-loading periods is the demand for which front-loading replenishment is necessary. In the graph 101, the excess demand exceeding the transport capacity TC in March and May is front-loaded to January and February, the excess demand exceeding the transport capacity TC in May is front-loaded to February, the excess demand exceeding the transport capacity TC in August is front-loaded to June, and the excess demand exceeding the transport capacity TC in December is front-loaded to June, September, and October. In the table 102, the bold-faced numerals at the end of the arrows are the transported item counts after front-loading.

In this manner, the demand exceeding the transport capacity TC during the busy periods is front-loaded to an off season period prior to the busy season and in which the transport truck unit cost is less expensive than during the busy period, resulting in the transportation volume being less than or equal to the transport capacity TC during the entire period of January to December. As a result, physical distribution companies can suppress transportation cost to the greatest degree possible with limited transportation resources. As a result, it is possible to reduce loss of sales opportunities resulting from shortages during the busy period, enabling an increase in sales profits.

<Hardware Configuration Example of Transportation Plan Generation Apparatus>

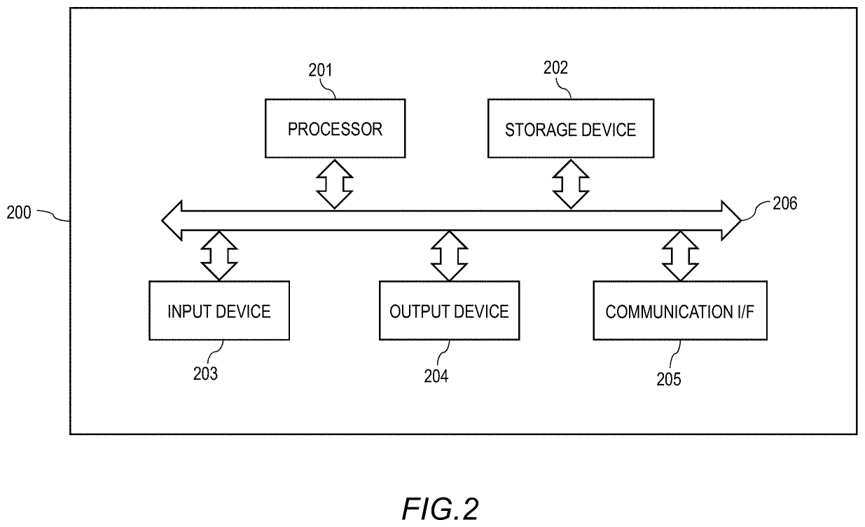

FIG. 2 is a block diagram for showing a hardware configuration example of the transportation plan generation apparatus. The transportation plan generation apparatus 200 has a processor 201, a storage device 202, an input device 203, an output device 204, and a communication interface (communication I/F) 205. The processor 201, the storage device 202, the input device 203, the output device 204, and the communication I/F 205 are connected by a bus 206. The processor 201 controls the transportation plan generation apparatus 200. The storage device 202 is the work area of the processor 201. Also, the storage device 202 is a non-transitory or transitory recording medium that stores various programs and data. Examples of such a storage device 202 include, for example, ROM (read only memory), RAM (random access memory), an HDD (hard disk drive), or a flash memory. The input device 203 is a device for inputting data. Examples of the input device 203 include a keyboard, a mouse, a touch panel, a numeric keypad, and a scanner. The output device 204 is a device for outputting data. Examples of the output device 204 include a display and a printer. The communication I/F 205 connects to the network and transmits/receives data.

<Mechanical Configuration Example of Transportation Plan Generation Apparatus 200>

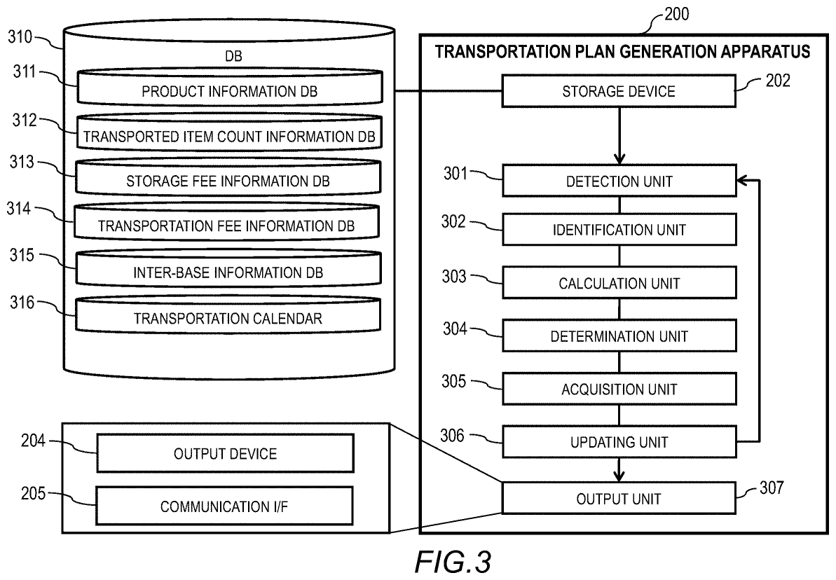

FIG. 3 is a block diagram showing a functional configuration example of the transportation plan generation apparatus 200. The transportation plan generation apparatus 200 has a detection unit 301, an identification unit 302, a calculation unit 303, a determination unit 304, an acquisition unit 305, an updating unit 306, and an output unit 307. The detection unit 301, the identification unit 302, the calculation unit 303, the determination unit 304, the acquisition unit 305, the updating unit 306, and the output unit 307 specifically are functions realized by a processor 201 executing programs stored in a storage device 202 shown in FIG. 2, for example.

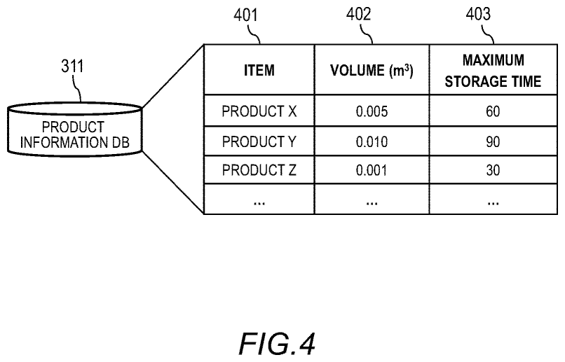

Also, the transportation plan generation apparatus 200 can access a database (DB) 310 outside of the transportation plan generation apparatus 200. The DB 310 includes a product information DB 311, a transported item count information DB 312, a storage fee information DB 313, a transportation fee information DB 314, an inter-base information DB 315, and a transportation calendar 316. The DB 310 may be stored in the storage device 202. First, the information in the DB 310 will be described with reference to FIGS. 4 to 9.

### [Information in DB 310]

FIG. 4 is a descriptive drawing showing one example of the product information DB 311. The product information DB 311 has, as fields, an item 401, a volume 402, and a maximum storage time 403. The combination of values in the fields of each row constitutes the product information of a single product. The item 401 is identification information (product code such as a JAN code, for example) indicating the type of product that is an example of an item to be transported. The volume 402 indicates the spatial volume taken up by the product corresponding to the item 401. The maximum storage time 403 is the maximum length of time that the product corresponding to the item 401 can be stored, and is set to a length of time shorter than the expiration date or best-by date of the product. The first row entry indicates product information in which the volume 402 of a product X is 0.005 m³, and the maximum storage time is 60 days.

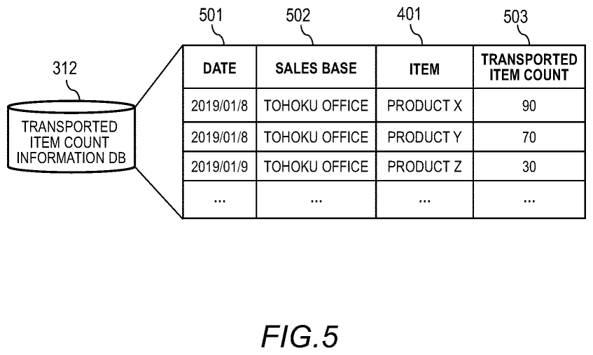

FIG. 5 is a descriptive drawing showing one example of the transported item count information DB 312. The transported item count information DB 312 has, as fields, a date 501, a sales base 502, the item 401, and a transported item count 503. The combination of values in the fields of each row constitutes one piece of transported item count information. The date 501 is the transportation date at which the product of the item 401 is transported to the sales base 502. The transportation date is the date at which the product of the item 401 is needed at the sales base 502, which may be a delivery date to the sales base or the shipping date to the sales base 502 of the product of the item 401.

The sales base 502 is a business office or a shop at which the product of the item 401 is sold, and is the transportation destination for the product identified by the item 401. The base can, in addition to the sales base 502, be a manufacturing base or an inventory base. The manufacturing base is a plant at which the product is manufactured, and the inventory base is a warehouse, plant, or business office at which the product is stored as inventory. Products manufactured at the manufacturing base are transported to the inventory base, and then transported from the inventory base to the respective sales bases 502. In the present embodiment, an example is described in which the product is transported from the inventory base to the sales bases, but the product may be transported from the manufacturing base to the inventory base, from the manufacturing base to the sales base, or from the inventory base to another inventory base.

The transported item count 503 is the number of products of the item 401 needed at the sales base 502. The entry in the first row indicates transported item count information stating that, where the date 501 is the delivery date, 90 products X are necessary at Tohoku Office, which is the sales base 502, by Jan. 8, 2019, as indicated by the date 501. If the date 501 is the shipping date, 90 products X are shipped to Tohoku Office, which is the sales base 502, by Jan. 8, 2019, as indicated by the date 501.

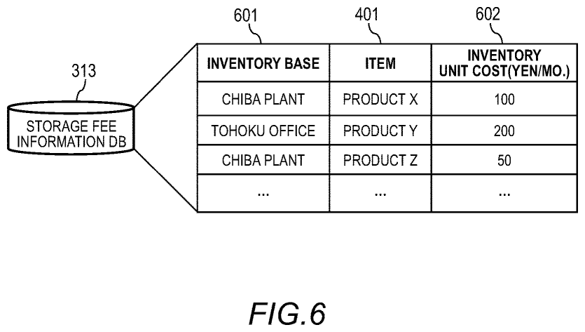

FIG. 6 is a descriptive drawing showing one example of the storage fee information DB 313. The storage fee information DB 313 has, as fields, an inventory base 601, the item 401, and an inventory unit cost 602. The combination of values in the fields of each row constitutes one piece of storage fee information. The inventory base 601 is a warehouse, plant, or business office at which the product is stored as inventory. The inventory unit cost 602 is the fee per period when one of the product of the item 401 is stored at the inventory base 601. Each period indicates the unit period for front-loading, which in this example is one month. The entry in the first row is storage fee information indicating that the inventory unit cost 602 is ¥100/month if the product X is stored at Chiba Plant, which is the inventory base 601.

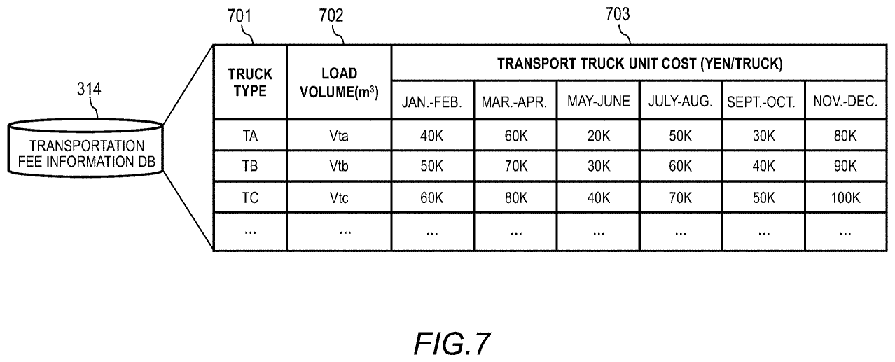

FIG. 7 is a descriptive drawing showing one example of the transportation fee information DB 314. The transportation fee information DB 314 has, as fields, a truck type 701, a load volume 702, and a transport truck unit cost 703. The combination of values in the fields of each row constitutes one piece of transportation fee information. The truck type 701 indicates the type of truck. The load volume 702 indicates the capacity that can by loaded onto a truck of the truck type. A transport truck unit cost 703 is a rental cost for one instance of transportation by one truck of the truck type. In FIG. 7, the transport truck unit cost 703 is defined in two-month increments. The entry of the first row is transportation fee information indicating that the transport truck unit cost 705 for one-time rental of one truck of a truck type 701 of Ta and a load volume 702 of Vta fluctuates in two-month increments.

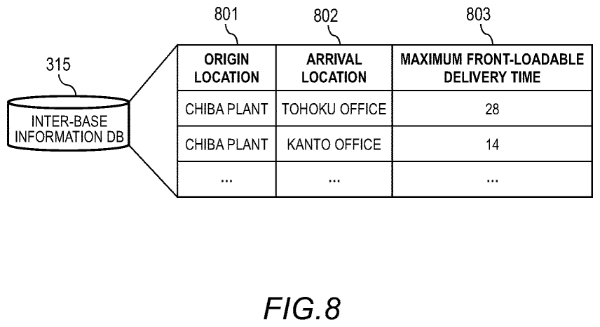

FIG. 8 is a descriptive drawing showing one example of the inter-base information DB 315. The inter-base information DB 315 has, as fields, an origin location 801, an arrival location 802, and a maximum front-loadable delivery time 803. The combination of values in the fields of each row constitutes one piece of inter-base information. The origin location 801 is the base from which the truck in the transportation plan departs. The arrival location 802 is the base where the truck arrives. The maximum front-loadable delivery time 803 is the maximum number of days that delivery can be front-loaded for the combination of origin location and arrival location. The entry in the first row is inter-base information indicating that the maximum front-loadable delivery time 803 is 28 days when transporting from the Chiba Plant to the Tohoku Office.

In other words, when transporting from the Chiba plant to the Tohoku Office, it is possible to front-load delivery by 28 days prior to the delivery date to the Tohoku Office, but front-loading by 29 days or longer is not possible. More specifically, if the delivery date is Aug. 29, 2019, for example, then it is possible to front-load delivery to Aug. 1, 2019, which is 28 days prior thereto, but front-loading to Jul. 31, 2019 or earlier is not possible.

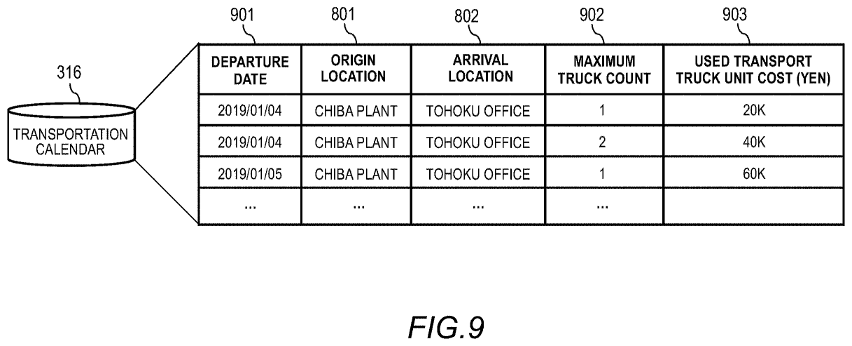

FIG. 9 is a descriptive drawing showing one example of the transportation calendar 316. The transportation calendar 316 is a transportation plan that defines a transportation schedule, and includes, as fields, a departure date 901, the origin location 801, the arrival location 802, a maximum truck count 902, and a used transport truck unit cost 903, for example. The combination of values in the fields of each row constitutes one transportation plan. The departure date 901 is the date at which the truck in the transportation plan departs from the origin location 801. The maximum truck count 902 is the maximum number of trucks used in the transportation plan.

The used transport truck unit cost 903 is the transport truck unit cost 703 over the period when the truck is used. The transport truck unit cost 703 when using a truck of a truck type 701 of TA in June is ¥20,000, and this is the used transport truck unit cost 903. The entry of the first row is a transportation plan indicating that a maximum of one truck with a used transport truck unit cost 903 of ¥20,000 for transportation from the Chiba Plant to the Tohoku Office is used for transportation on Jan. 4, 2019.

Returning to FIG. 3, the functions of the transportation plan generation apparatus 200 will be described. The detection unit 301 detects a front-loading period T. Specifically, as shown in FIG. 1, the detection unit 301 detects March, May, August, and December when the transport capacity TC is exceeded as the front-loading periods T, for example.

The identification unit 302 detects a front-loadable period S. Specifically, as shown in FIG. 1, for example, the identification unit 302 identifies, as the front-loadable period S for each front-loading period T, a period that is prior to the front-loading period T, in which demand is less than or equal to the transport capacity TC, and to which the excess demand during the front-loading period T, which is the amount by which demand has exceeded the transport capacity TC, can be shifted. In the example of FIG. 1, if the front-loading period T is August, then the front-loadable periods S are April, June, and July.

The calculation unit 303 calculates a front-loading priority. The front-loading priority is an indicator for front-loading the transportation of a product from the front-loading period T to the front-loadable period S, and is calculated for each combination of product and front-loadable period S. The higher the front-loading priority is for a given combination, the easier the transportation can be front-loaded.

The determination unit 304 determines the front-loading product and the front-load period on the basis of the front-loading priority calculated by the calculation unit 303 for each combination of product and front-loadable period S. Specifically, for example, the determination unit 304 determines the product with the maximum front-loading priority as a product to be front-loaded, and determines the period to which excess demand from the front-loading period T is to be shifted to the front-loadable period S with the maximum front-loading priority.

The acquisition unit 305 calculates the maximum front-loadable count. The maximum front-loadable count is the maximum number of additionally transportable products according to the number of products being transported prior to the front-loading of the product in the front-loading period T and the transportation capability for the product in the front-loadable period S.

The updating unit 306 updates the transported item count and the allocated transportation capability on the basis of the maximum front-loadable count. Specifically, for example, the updating unit 306 reduces a transported item count xᵢₜ of a product i of the front-loading period t by the maximum front-loadable count. Similarly, the updating unit 306 reduces an allocated transportation capability eₜ of the front-loading period t by an amount calculated by multiplying the maximum front-loadable count by the volume 402 of the product i. Also, the updating unit 306 increases a transported item count xᵢₛ of the product i of the front-loadable period s by the maximum front-loadable count. Similarly, the updating unit 306 increases an allocated transportation capability eₛ of the front-loadable period s by the amount calculated by multiplying the maximum front-loadable count by the volume 402 of the product i. The updating unit 306 repeatedly executes the above-mentioned update process until the allocated transportation capability eₜ of the front-loading period t falls below the maximum transportation capability Eₜ (that is, the transport capacity TC).

The output unit 307 outputs the update results from the updating unit 306. Specifically, for example, the output unit 307 may output the update results so as to be displayable in the output device 204, or may transmit the update results to another computer accessible via the communication I/F 205. [Calculation Example for Front-Loading Priority]

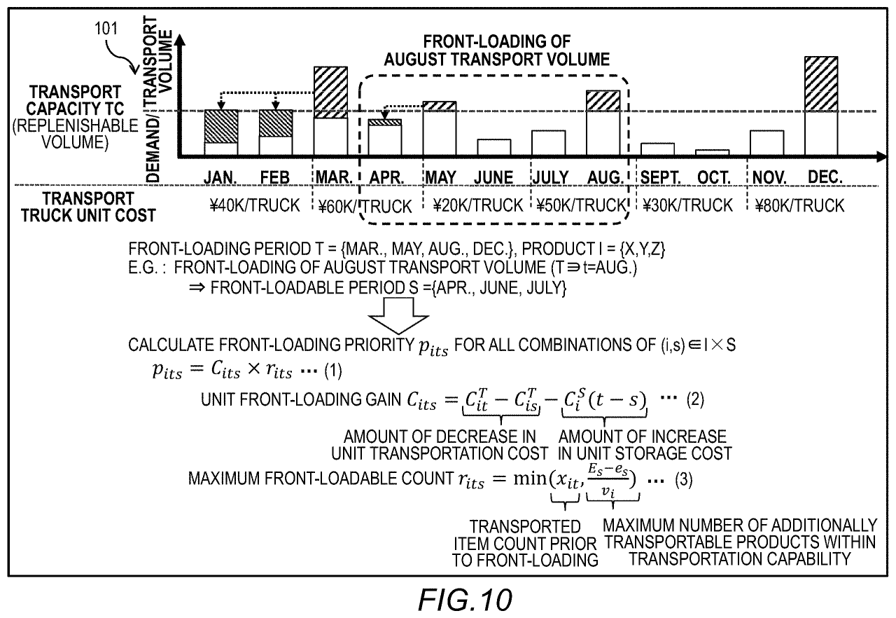

FIG. 10 is a descriptive drawing showing a calculation example for the front-loading priority by the calculation unit 303. In the graph 101, the front-loading periods T in which the demand exceeds the transport capacity TC are March, May, August, and December. In FIG. 10, the front-loading period T [symbol] t=August, and a to-be-front-loaded product I=X, Y, Z.

The front-loadable periods S for when the front-loading period T is August are April, June, and July when the demand is less than or equal to the transport capacity TC. Since January and February have additional products added through front-loading as a result of the front-loading period T [symbol] t=March, and thus, January and February are not included in the front-loadable period S for when the front-loading period t=August.

The calculation unit 303 calculates a front-loading priority pᵢₜₛ for when the transportation of a product i∈I is front-loaded from the front-loading period t to the front-loadable period s∈S for all combinations of (i,s)∈I×S. The priority pᵢₜₛ is calculated by the following formula (1).

pᵢₜₛ=Cᵢₜₛ×rᵢₜₛ (1)

In formula (1), Cᵢₜₛ is the unit front-loading gain for when the transportation of the product i∈I is front-loaded from the front-loading period t to the front-loadable period s∈S. The unit front-loading gain Cᵢₜₛ is calculated by the following formula (2).

Cᵢₜₛ=C^{T}ᵢₜ−C^{T}ᵢₛ−C^{S}ᵢ(t−s) (2)

C^{T}ᵢₜ in formula (2) is the transportation cost for one product i in the front-loading period t. The transportation cost C^{T}ᵢₜ is a value attained by dividing the used transport truck unit cost 705 during the front-loading period t for one truck of the truck type 701 in use by the load volume 702 for the truck type 701, and multiplying the resulting value by the volume 402 of the product i.

C^{T}ᵢₛ in formula (2) is the transportation cost for one product i in the front-loadable period s. The transportation cost C^{T}ᵢₛ is a value attained by dividing the transport truck unit cost 705 during the front-loadable period s for one truck of the truck type 701 in use by the load volume 702 for the truck type 701, and multiplying the resulting value by the volume 402 of the product i. C^{T}ᵢₜ−C^{T}ᵢₛ in formula (2) is the amount of decrease in the unit transportation cost. The unit transportation cost is the transportation cost for one product i being front-loaded by a period of time equal to t-s.

C^{S}ᵢ in formula (2) is the storage cost for one product i over one period (one month in this example). Also, C^{S}ᵢ(t−s) in formula (2) is the amount of increase in the unit storage cost. The unit storage cost is the storage cost for one product i being front-loaded by a period of time equal to t-s.

In formula (1), rᵢₜₛ is the maximum front-loadable count for when the transportation of the product i∈I is front-loaded from the front-loading period t to the front-loadable period s∈S. The maximum front-loadable count rᵢₜₛ is calculated by the following formula (3).

rᵢₜₛ=min(xᵢₜ,(Eₛ−eₛ)/vᵢ) (3)

xᵢₜ in formula (3) is the transported item count for the product i in the front-loading period t. Eₛ in formula (3) is the transport capacity TC for the product i that is the maximum possible transportation volume over the front-loading period t. eₛ in formula (3) is the allocated transportation volume during the front-loading period t. vᵢ in formula (3) is the transportation capability necessary for transportation per product i, and corresponds to the volume 402. The right hand side of formula (3) (Eₛ−eₛ)/vᵢ is the maximum number of products i that can be additionally transported within the transportation capability in the front-loadable period s.

### [Determination Example for Front-Loaded Product and Front-Load Period and Data Update Example]

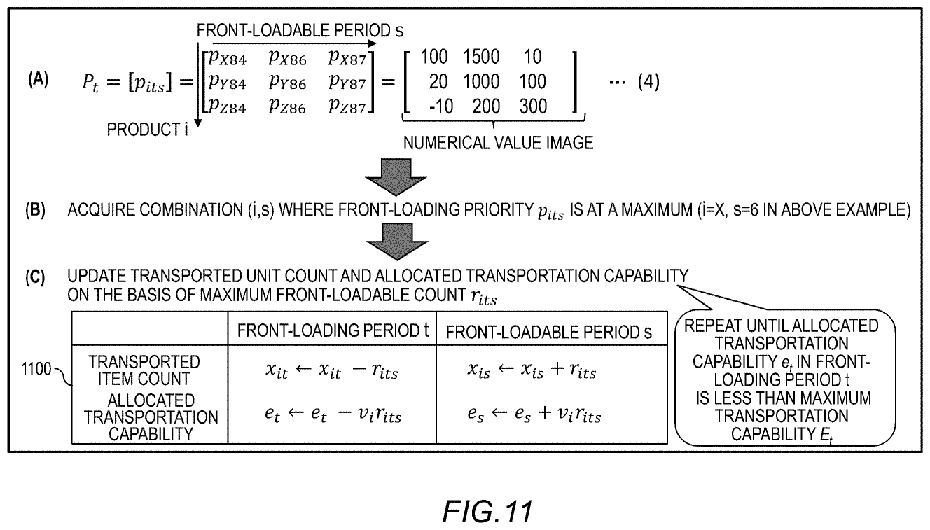

FIG. 11 is a descriptive drawing showing a determination example for the front-loaded product and the front-load period, and a data update example. Determination of the front-loaded product and the front-load period is executed by the determination unit 304, and the updating of data is executed by the acquisition unit 305 and the updating unit 306.

(A) shows a matrix Pₜ attained when calculating the front-loading priority pᵢₜₛ for all combinations of (i,S)∈I×S (formula (4)). In formula (4), the product i=X, Y, Z (column direction of matrix Pₜ), the front-loading period t=August, and the front-loadable period s=4, 6, 7 (row direction of matrix Pₜ). However, elements of the front-loadable period s that exceed the maximum front-loadable delivery time 803 belonging to the inter-base information DB 315 are deleted. For example, if the front-loadable period s=April is at a date away from the front-loading period t=August (1st, for example) by the maximum front-loadable delivery time 803, then the front-loading priorities p_{X84}, p_{Y84}, and p_{Z84} are deleted (or not calculated).

(B) The determination unit 304 acquires a combination (i, s) between the product i and the front-loadable period s for which the front-loading priority pᵢₜₛ is at a maximum among all elements of the matrix Pₜ. In the above example, the maximum value for the front-loading priority pᵢₜₛ is front-loading priority p_{X86}=1500. Thus, the combination (i, s) between the product i and the front-loadable period s at the front-loading priority p_{X86} is (i, s)=(X, 6). In other words, it can be understood that it would be optimal for a product X to be front-loaded from the front-loading period t=August to the front-loadable period s=June.

(C) The acquisition unit 305 acquires the maximum front-loadable count rᵢₜₛ from the front-loading period t for a combination (i, s) between the product i and the front-loadable period s for which the front-loaded priority pᵢₜₛ is at a maximum. The maximum front-loadable count rᵢₜₛ is calculated by the calculation unit 303. In (B), t=8 and (i, s)=(X, 6), and thus, the acquisition unit 305 acquires the maximum front-loadable count r_{X86}.

Then, the updating unit 306 updates the transported item count and the allocated transportation capability on the basis of the acquired maximum front-loadable count rᵢₜₛ. As shown in table 1100, the transported item count xᵢₜ for the product i in the front-loading period t is updated to xᵢₜ−rᵢₜₛ. In other words, the transported item count xᵢₜ decreases by the front-loaded amount. Similarly, the allocated transportation capability eₜ in the front-loading period t is updated to eₜ−vᵢ·rᵢₜₛ. In other words, the allocated transportation capability eₜ also decreases by the front-loaded amount.

Meanwhile, the transported item count xᵢₛ for the product i in the front-loading period s is updated to xᵢₛ+rᵢₜₛ. In other words, the transported item count xᵢₛ increases by the front-loaded amount. Similarly, the allocated transportation capability eₜ in the front-loadable period s is updated to eₛ+vᵢ·rᵢₜₛ. In other words, the allocated transportation capability eₜ also increases by the front-loaded amount. The data update shown in table 1100 is repeatedly executed until the allocated transportation capability eₜ of the front-loading period t falls below the maximum transportation capability Eₜ (that is, the transport capacity TC).

<Example of Transportation Plan Generation Process Steps>

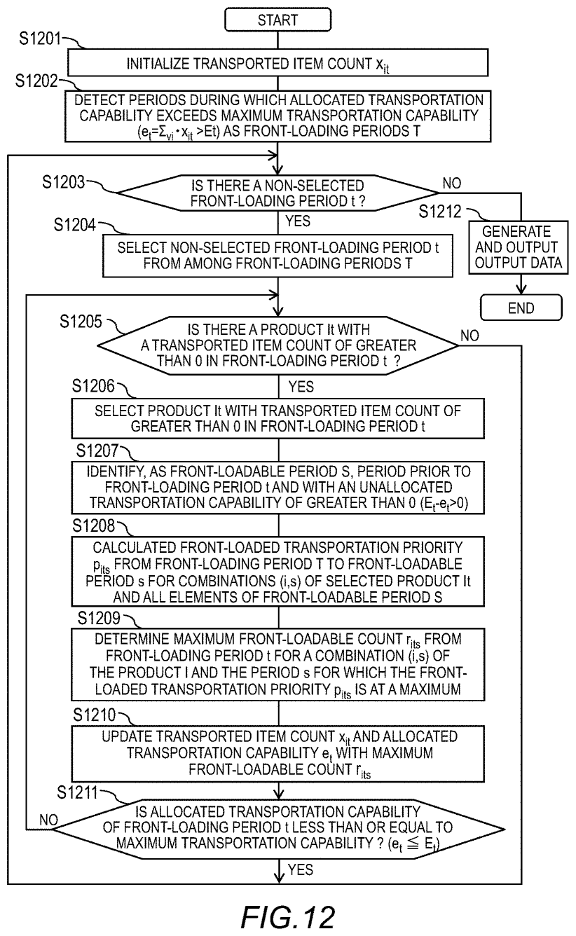

FIG. 12 is a flowchart showing an example of transportation plan generation process steps by the transportation plan generation apparatus 200.

First, the transportation plan generation apparatus 200 initializes the transported item count xᵢₜ as transported item count xᵢₜ=demand Dᵢₜ (step S1201). Specifically, for example, the transportation plan generation apparatus 200 refers to the transported item count information DB 312 to aggregate the transported item counts 503 for each product i by month for the same sales base 502 (transportation destination), and sets the transported item count xᵢₜ for the product i by month as the initial value.

Next, the transportation plan generation apparatus 200 detects, as the front-loading periods T, periods in which the allocated transportation capability (eₜ=Σvᵢ·xᵢₜ) that is the transportation volume exceeds the maximum transportation capability Et (et>Et) (step S1202). In the example of FIG. 10, the front-loading periods T={March, May, August, December} are detected for the products I={X, Y, Z}.

Next, the transportation plan generation apparatus 200 determines whether the detected front-loading period T={March, May, August, December} includes a non-selected front-loading period t (step S1203). If there is a non-selected front loading period t (step S1203:Yes), then the transportation plan generation apparatus 200 selects the non-selected front-loading period t from the front-loading periods T (step S1204).

Next, the transportation plan generation apparatus 200 determines whether there is a product It in which the transported item count xᵢₜ in the front-loading period t selected in step S1204 is greater than 0 (step S1205). The transported item count xᵢₜ is the initial value set in step S1201 before the updating performed in step S1208, and is the latest value updated in step S1208 after the updating performed in step S1208.

If there is a product It in which the transported item count xᵢₜ in the front-loading period t is greater than 0, then the transportation plan generation apparatus 200 selects the product It in which the transported item count xᵢₜ in the front-loading period t selected in step S1204 is greater than 0 (step S1206).

Next, the transportation plan generation apparatus 200 identifies, as front-loadable periods S, periods prior to the front-loading period t and during which an unallocated transportation capability (Eₜ−eₜ) is greater than 0 (step S1207). In the example of FIG. 10, if the front-loading period t=August, then the front-loadable periods S={April, June, July}. If the front-loadable periods S are not identified, then the process progresses to step S1203.

Next, the transportation plan generation apparatus 200 calculates the front-loaded priority pᵢₜₛ from the front-loading period t to the front-loadable period s for combinations (i,s) of a selected product It and all elements of the front-loadable periods S (step S1208). Specifically, a matrix Pₜ is calculated as indicated in (A) of FIG. 11, for example. As a result, it is possible to front-load transportation with priority to periods during which the transport truck unit cost 703 is less expensive than other periods.

Next, the transportation plan generation apparatus 200 determines the maximum front-loadable count rᵢₜₛ from the front-loading period t for a combination (i, s) between the product i and the period s for which the front-loading priority pᵢₜₛ is at the maximum (step S1209). Specifically, for example, in the example of (A) in FIG. 11, the front-loading priority p_{X86}=1500 in which i=X and s=6 is the maximum value, and thus, (X,6) is selected as the combination (i,s) of the product i and the period s during which the front-loaded priority pᵢₜₛ is at the maximum. Thus, the transportation plan generation apparatus 200 determines the maximum front-loadable count rᵢₜₛ from the front-loading period t as the maximum front-loadable count r_{X86}. As a result, it is possible to select the product with the highest degree of cost reduction per unit from among a plurality of front-loading candidate products.

Next, the transportation plan generation apparatus 200 updates the transported item count xᵢₜ and the allocated transportation capability eₜ using the maximum front-loadable count rᵢₜₛ (step S1210). Specifically, for example, the transportation plan generation apparatus 200 updates the transported item count xᵢₜ, the allocated transportation capability eₜ, the transported item count xᵢₛ, and the allocated transportation capability eₛ as indicated in table 1100 in (C) of FIG. 11.

Next, the transportation plan generation apparatus 200 determines whether a necessary transportation capability eₜ of the front-loading period t is less than or equal to the maximum transportation capability Eₜ (step S1211). As a result, it is possible to take into consideration the capability of transporting all products in question to the base. If the necessary transportation capability eₜ of the front-loading period t is not less than or equal to the maximum transportation capability Eₜ (step S1211: No), then there is still a quantity of items to be transported that need to be front-loaded in the front-loading period t, and thus, the process returns to step S1205. In this case, in step S1205, the latest transported item count xᵢₜ updated in step S1210 is used in step S1205.

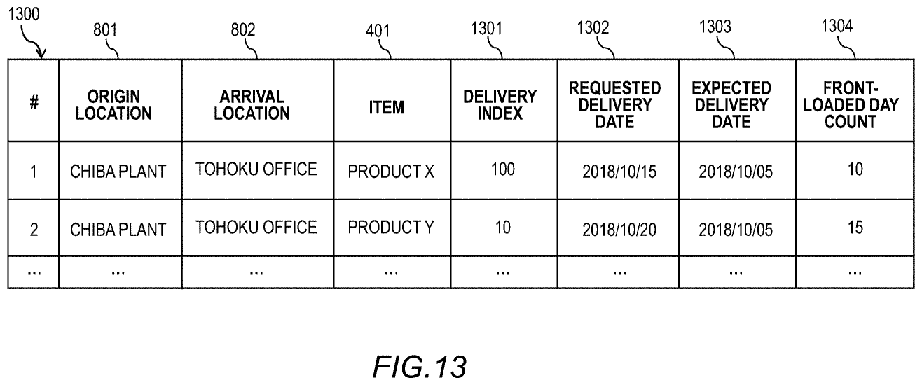

On the other hand, if the allocated transportation capability eₜ of the front-loading period t is less than or equal to the maximum transportation capability Eₜ (step S1211: Yes), then the excess transportation volume has been front-loaded in the front-loading period t, and thus, the process returns to step S1203. In step S1203, if there is no non-selected front-loading period t (step S1203: No), then the transportation plan generation apparatus 200 generates output data to be described later with reference to FIGS. 13 to 17 on the basis of the final update results of step S1208 and the DB 310, outputs the output data via the output device 204 or the communication I/F 205 (step S1212), and ends the series of processes.

<Output Data Example>

An output data example will be described with reference to FIGS. 13 to 17. The output data below is outputted in step S1210 of FIG. 12. Also, the output data below specifically may be displayed by the output device 204 of the transportation plan generation apparatus 200, or may be displayed by an output device 204 of another computer that can be accessed via the communication I/F 205, for example.

FIG. 13 is a descriptive drawing showing item-based transportation plan data. The item-based transportation plan data 1300 is transportation plan data for each item. The item-based transportation plan data 1300 includes, as fields, the origin location 801, the arrival location 802, the item 401, a delivery index 1301, a requested delivery date 1302, an expected delivery date 1303, and a front-loaded day count 1304.

The delivery index 1301 is the number of products of the item 401 to be delivered from the origin location 801 to the arrival location 802, and is the transported item count xᵢₛ, xᵢₜ of the product i attained from the final update results by the updating unit 306. The requested delivery date 1302 is a delivery date prior to front-loading requested by the arrival location 802, and is selected automatically or by user operation from the front-loading period t.

The expected delivery date 1303 is the delivery date after the above-mentioned front-loading, and is selected automatically or by user operation from the front-loading period t (if not front-loaded) or the front-loadable period s (if front-loaded). The front-loaded day count 1304 is the number of days calculated by subtracting the expected delivery date 1303 from the requested delivery date 1302. The item-based transportation plan data 1300 is generated on the basis of the final update results by the updating unit 306, the transported item count information DB 312, and the transportation calendar 316.

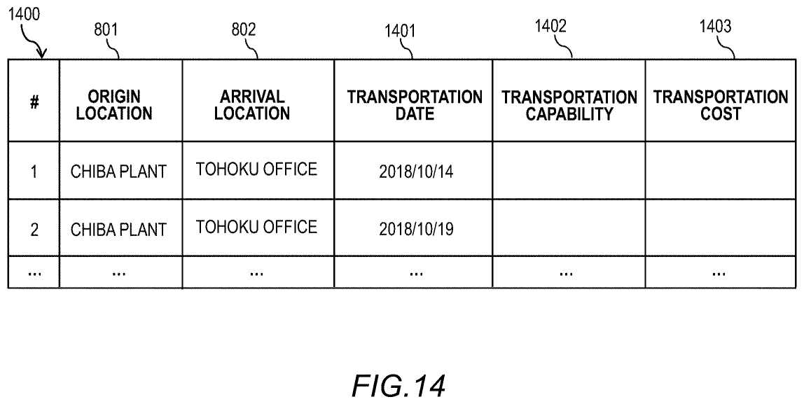

FIG. 14 is a descriptive drawing showing inter-base transportation plan data. The inter-base transportation plan data 1400 is transportation plan data pertaining to the combination of the origin location 801 and the arrival location 802. The inter-base transportation plan data 1400 includes, as fields, the origin location 801, the arrival location 802, a transportation date 1401, a transportation capability 1402, and a transportation cost 1403. The transportation date 1401 is a shipping date (departure date of truck) from the origin location 801.

The transportation capability 1402 is the total capacity for products to be transported from the origin location 801 to the arrival location 802 on the transportation date 1401, and is the transportation capability eₜ, eₛ for the period including the transportation date 1401 attained from the final update results by the updating unit 306. The transportation cost 1403 is the amount of money calculated by multiplying the number of trucks of the truck type 701 chartered on the transportation date 1401 by the transport truck unit cost. Specifically, for example, the transportation cost 1403 is the amount of money calculated by multiplying the maximum truck count of the transportation calendar 316 by the used transport truck unit cost. The inter-base transportation plan data 1400 is generated on the basis of the final update results by the updating unit 306, the transported item count information DB 312, the transportation calendar 316, and the transportation fee information DB 314.

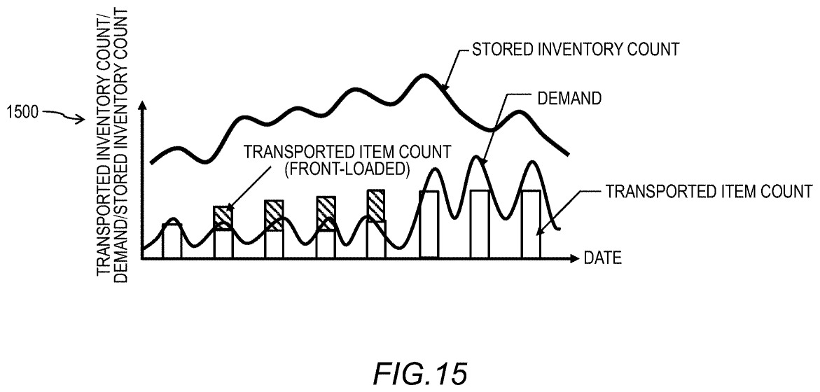

FIG. 15 is a descriptive drawing showing inventory transition data. The inventory transition data 1500 is prediction data where the horizontal axis is the date, and the vertical axis is the transported item count xᵢₜ, xᵢₛ, the demand, and the stored inventory count. The bar graph indicates the transported item count. The transported item count with a hatching pattern is the front-loaded transported item count. The stored inventory count is the inventory count of each stored product (not shown), which increases as products arrive and decreases as the products are shipped. In this example, as a result of the front-loaded transported item count, the stored inventory count increases prior to the increase in demand and decreases as the demand increases.

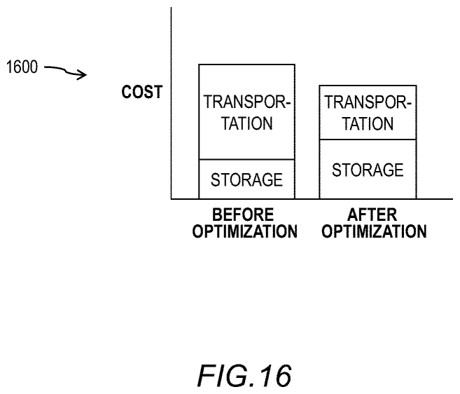

FIG. 16 is a descriptive drawing showing cost breakdown data. The cost breakdown data 1600 is a bar graph showing the cost prior to optimization (prior to front-loading) and the cost after optimization (after front-loading). “Transportation” indicates the transportation cost 1403. “Storage” indicates the storage cost attained by performing a product-sum operation on the inventory unit cost 602 at the inventory base that is the destination for the product and the number of products in inventory. Thus, it is possible to reduce the physical distribution cost including the storage cost along with the transportation cost.

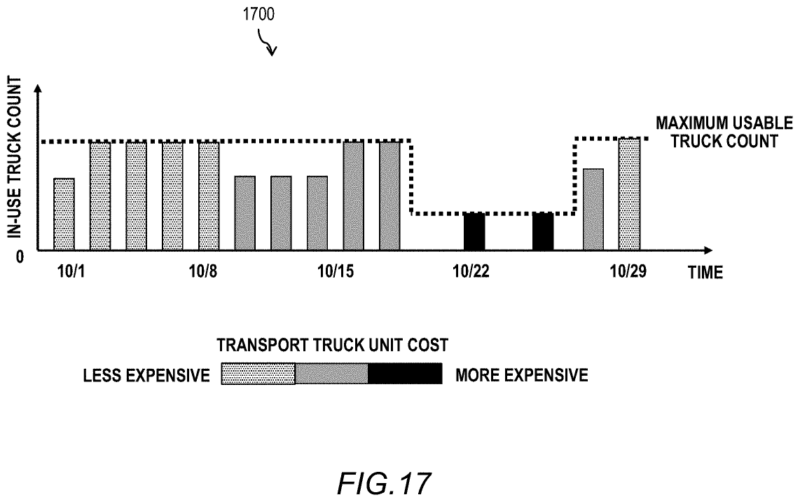

FIG. 17 is a graph indicating the transition in the in-use truck count. The horizontal axis of graph 1700 indicates time and the vertical axis indicates the in-use truck count. The transportation plan generation apparatus 200 calculates the in-use truck count by allocating the truck type 701 to the demand after front-loading. By performing front-loading, the in-use truck count increases when the transport truck unit cost 703 is low, and the in-use truck count decreases when the transport truck unit cost 703 is high.

If the user performs input allowing front-loading on the transportation plan generation apparatus 200 with reference to the output data of FIGS. 13 to 17, the transportation plan generation apparatus 200 updates the date 501 and the transported item count 503 of the transported item count information DB 312 according to the final update results.

Thus, according to Embodiment 1, by calculating the front-loading priority pᵢₜₛ, the transportation plan generation apparatus 200 can front-load transportation with priority to periods during which the transport truck unit cost 703 is less expensive than other periods. Also, using the determination unit 304, the transportation plan generation apparatus 200 can select for front-loading the product with the highest degree of cost reduction per unit from among a plurality of front-loading candidate products. Also, using the updating unit 306, the transportation plan generation apparatus 200 can suppress the transportation capability (transportation volume) for transporting all relevant products to the base to less than or equal to the transport capacity TC when performing front-loading.

### Embodiment 2

Embodiment 2 is an example of predicting the transport truck unit cost and the transportation capability. Components in common with Embodiment 1 are assigned the same reference characters and descriptions thereof will be omitted.

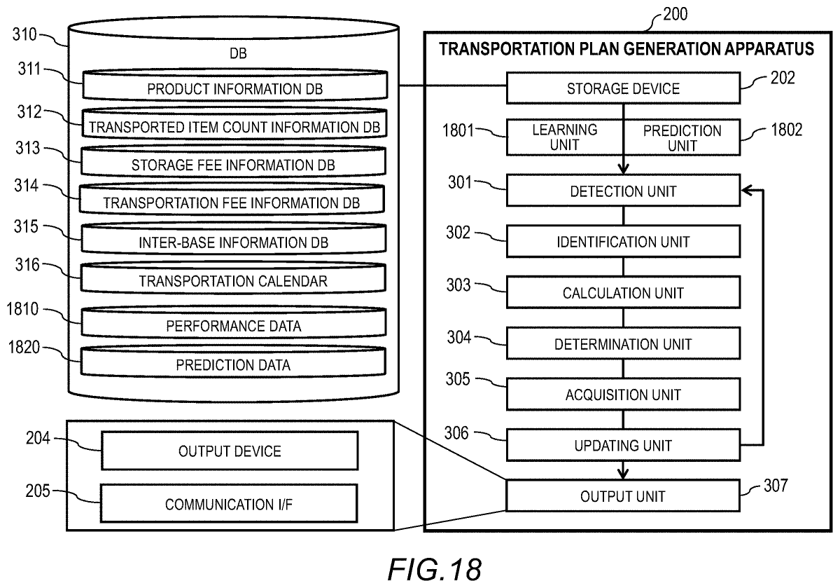

FIG. 18 is a block diagram showing a functional configuration example of the transportation plan generation apparatus 200 according to Embodiment 2. The difference from Embodiment 1 is that the transportation plan generation apparatus 200 additionally has a learning unit 1801 and a prediction unit 1802, and the DB 310 additionally has performance data 1810 and prediction data 1820.

The learning unit 1801 acquires the performance data 1810 and generates a learning model through machine learning. Specifically, for example, the learning unit 1801 generates a learning model through linear regression or autoregression such as ARIMA. The prediction unit 1802 outputs prediction results by inputting the prediction data 1820 into the learning model.

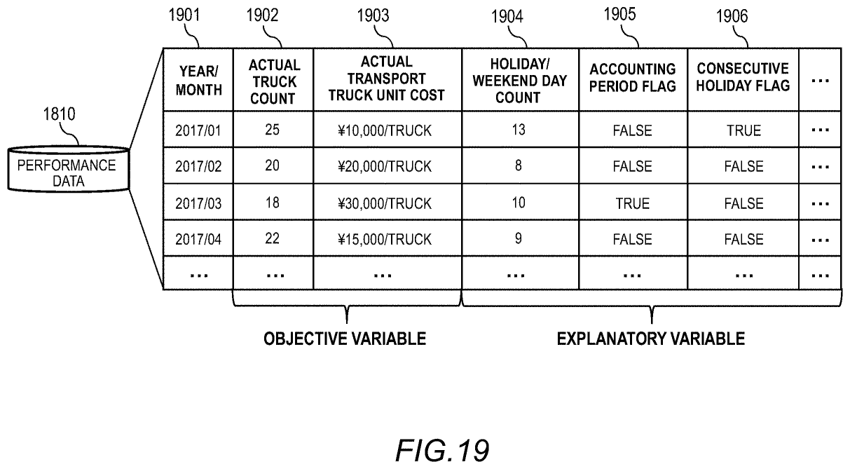

FIG. 19 is a descriptive view showing an example of the performance data. The performance data 1810 includes a year/month 1901, an actual truck count 1902, an actual transport truck unit cost 1903, a holiday/weekend day count 1904, an accounting period flag 1905, and a consecutive holiday flag 1906. The year/month 1901 indicates the year and the month at which the product was transported. The actual truck count 1902 is the number of trucks chartered during the year/month 1901. In reality, there are trucks of each truck type 701, and thus, it is preferable to consider the transportation capability (total capacity), but in order to simplify the explanation, it is assumed that the actual truck count is the number of trucks of one given truck type 701 that transported the product.

The actual transport truck unit cost 1903 is the transport truck unit cost of trucks chartered during the year/month 1901. The actual truck count 1902 and the actual transport truck unit cost 1903 are the objective variables for machine learning.

The holiday/weekend day count 1904 is the number of days off that are included in the year/month 1901. The greater the holiday/weekend day count 1904 is, the higher the transportation frequency tends to be, for example, although this is dependent on the product type. The accounting period flag 1905 is a flag indicating whether the year/month 1901 is in the accounting period.

The consecutive holiday flag 1906 is a flag indicating whether there are consecutive holidays in the year/month 1901. The holiday/weekend day count 1904, the accounting period flag 1905, and the consecutive holiday flag 1906 are the explanatory variables in machine learning.

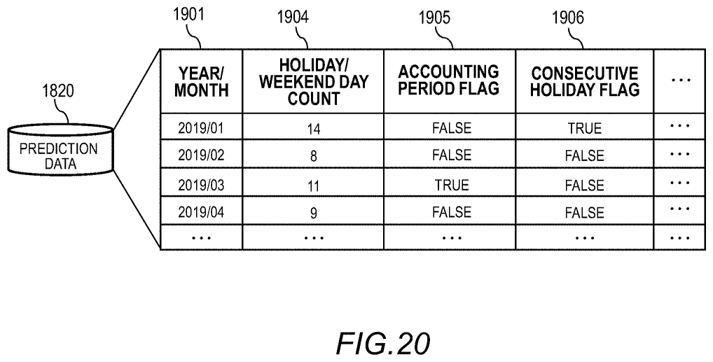

FIG. 20 is a descriptive view showing an example of the prediction data. The prediction data 1820 includes the year/month 1901, the holiday/weekend day count 1904, the accounting period flag 1905, and the consecutive holiday flag 1906. The holiday/weekend day count 1904, the accounting period flag 1905, and the consecutive holiday flag 1906 of the prediction data 1820 are prediction values for a future year/month 1901, and are inputted into the learning model generated by the learning unit 1801.

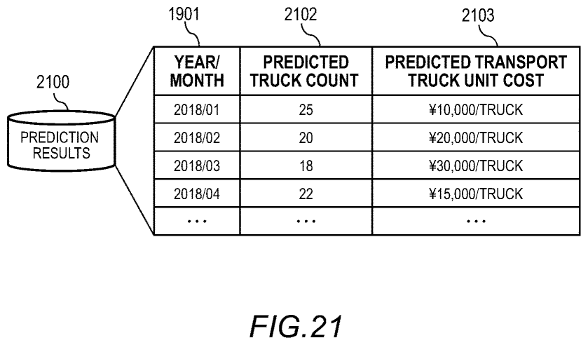

FIG. 21 is a descriptive view showing an example of a prediction result. The prediction result 2100 is data outputted as a result of the prediction data 1820 being inputted into the learning model. The prediction result 2100 includes the year/month 1901, a predicted truck count 2102, and a predicted transport truck unit cost 2103. The predicted truck count 2102 is the number of trucks predicted to be used at a future year/month 1901. Regarding the predicted truck count 2102 as well, in reality, there are trucks of each truck type 701, and thus, it is preferable to consider the transportation capability (total capacity), but in order to simplify the explanation, it is assumed that the actual truck count is the number of trucks of one given truck type 701 that transported the product. The predicted transport truck unit cost 2103 is the transport truck unit cost 703 during the year/month 1901.

In this manner, by generating the learning model from the performance data 1810 and attaining the prediction result 2100 by applying the prediction data 1820 to the learning model, the transportation plan generation apparatus 200 can use the prediction result 2100 in the detection unit 301. Specifically, for example, the transportation plan generation apparatus 200 can predict the demand for the year/month 1901 according to the predicted truck count 2102 and the truck type 701, and the predicted transport truck unit cost 2103 can be used as the transport truck unit cost 703 for that year/month 1901.

### Embodiment 3

Embodiment 3 is an example in which a transportation plan is generated with consideration to the characteristics of the product. Components in common with Embodiments 1 and 2 are assigned the same reference characters and descriptions thereof will be omitted.

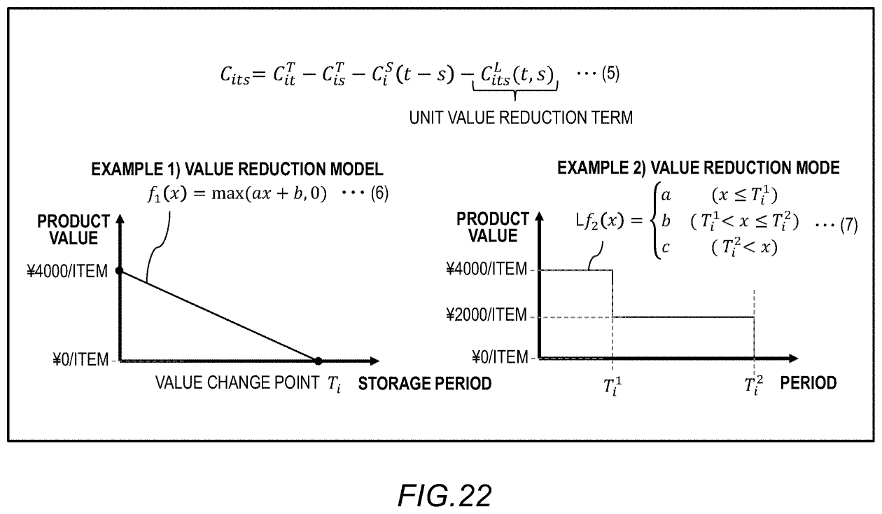

FIG. 22 is a descriptive drawing showing an evaluation example value loss cost according to Embodiment 3. If the storage period for a product is extended due to excessive front-loading of transportation thereof, then the value of the product deteriorates due to degradation of the product. In order to consider the value of the product, the transportation plan generation apparatus 200 calculates a unit value reduction term C^{L}ᵢₜₛ(t,s) in the unit front-loading gain Cᵢₜₛ of formula (5).

E.g. 1: the value gradually decreases the longer the product is stored (best-by date, etc.)

Where the unit value reduction amount [f₁(0)−f₁(t−s)] based on the storage period t-s is a unit value reduction term C^{L}ᵢₜₛ, f₁(x) is represented by the following formula (6).

f₁(x)=max(ax+b,0) (6)

a is the slope of f₁(x) and b is the intercept of f₁(x). xᵢₛ the storage period, and f₁(x) is the product value (such as the product unit cost).

E.g. 2: the value fluctuates around a given period (for event-based products, etc.)

Where the difference f₂(t)−f₂(s) in value of the product i during the period (t,s) is a unit value reduction term C^{L}ᵢₜₛ, f₂(x) is represented by the following formula (7).

$$\begin{matrix}{f}_{2} ( x ) = a ( x \leq {T}_{i}^{1} ) \\ = b ( {T}_{i}^{1} < x \leq {T}_{i}^{2} ) \\ = c ( {T}_{i}^{2} < x )\end{matrix} \qquad ( 7 )$$

x is a period, and a to c are the product values (such as the product unit cost). T¹ᵢ is a first value change point of the product i, and T²ᵢ (>T¹ᵢ) is a second value change point of the product i. The period of T1i<x≤T2i is an event period. As one example, the product value is highest before the event, the product value is reduced as compared to before the event but is maintained at a certain level during the event, and after the event, the product value is reduced to less than or equal to a prescribed value, including cases in which the product value is worthless, for example.

The calculation unit 303 applies the unit value reduction term C^{L}ᵢₜₛ(t,s) to the unit front-loading gain Cᵢₜₛ, thereby allowing for suitable calculation of the front-loading priority pᵢₜₛ even for products in which the product value fluctuates depending on the number of days that the product is stored. In Embodiment 3, an example was described in which the product value decreases over time, but a unit value increase term in which the product value increases over time may be applied to the unit front-loading gain Cᵢₜₛ.

Thus, according to the transportation plan generation apparatus 200 of Embodiments 1 to 3, when formulating transportation instructions, for example, it is possible to realize a reduced transportation cost, and furthermore, a reduced physical distribution cost, which also includes storage cost, by controlling the transported item count 503 and the transportation period for a plurality of products, in consideration of changes in the transport truck unit cost 703 and the transportation capability eₜ, eₛ depending on the period, which occurs if renting trucks, which are the transportation means, from a third party by contract.

Thus, the shipper, which is the user of the transportation plan generation apparatus 200, can avoid sales opportunity loss resulting from insufficient products while reducing transportation cost amid limited transportation resources, and furthermore, reduce the physical distribution cost, which also includes storage cost, enabling increased sales profits.

The transportation plan generation apparatus 200 according to Embodiments 1 to 3 can also have the following configurations (1) to (21).

(1) The transportation plan generation apparatus 200 can access the transported item count information DB 312 that stores the date 501, the item 401, and the transported item count 503 in association with each other, the product information DB 311 that stores the item 401 and the volume 402 in association with each other, and the transportation fee information DB 314 that stores the truck type 701, the load volume 702, and the transport truck unit cost 703 for each period in association with each other, and is configured to execute: a detection process of detecting the front-loading period T, among a plurality of periods, during which the transportation volume for each period based on transported item count 503 and the volume 402 exceeds the transport capacity TC; an identification process of identifying the front-loadable periods S that are prior to the front-loading period T detected by the detection process, and that do not correspond to the front-loading period T; a determination process of determining a given front-loadable period S during which the fee of the transportation means is less expensive than for the front-loading period T, among the front-loadable periods S identified in the identification process, to be a period to which a portion of the transportation volume of the front-loading period T is reallocated; and an output process of outputting determination results of the determination process.

As a result, it is possible to identify the period to which a portion of the transportation volume in the front-loading period T is to be front-loaded, and to reduce transportation cost.

(2) In (1), the transportation plan generation apparatus 200 is configured to execute a calculation process of calculating, for each product of the item 401, the front-loading priority pᵢₜₛ at which the portion of the transportation volume of the front-loading period T is reallocated from the front-loading period T to the front-loadable periods S, on the basis of a first transport truck unit cost for transporting the product of the item 401 of the front-loading period T during the front-loading period T using the truck of the truck type 701, and a second transport truck unit cost for transporting the product of the item 401 during the front-loadable periods S using the truck of the truck type 701, and in the determination process, the transported item count 503 of the product of the given item 401 in the front-loading period T and the given front-loadable period S are determined on the basis of the front-loading priority pᵢₜₛ for each of the products of the item 401 calculated in the calculation process.

As a result, for a front-loading period T of August and a front-loadable period S of April, for example, the transportation plan generation apparatus 200 calculates the front-loading priorities p_{X84}, p_{Y84}, and p_{Z84} for each product X, Y, and Z, and the front-loading priority p_{X84} of 100, which is the maximum value among the front-loading priorities p_{X84}, p_{Y84}, and p_{Z84}, is selected. Thus, the transportation plan generation apparatus 200 can generate a transportation plan with the least expense among the products X, Y, and Z of front-loading the transported item count 503 of the front-loading period T of August for the product X to the front-loadable period S of April.

(3) In (1), the transportation plan generation apparatus 200 is configured to execute a calculation process of calculating, for each front-loadable period S, the front-loading priority pᵢₜₛ at which the portion of the transportation volume of the front-loading period T is reallocated from the front-loading period T to the front-loadable periods S, on the basis of a first transport truck unit cost for transporting the product of the item 401 of the front-loading period T during the front-loading period T using the truck of the truck type 701, and a second transport truck unit cost for transporting the product of the item 401 during the front-loadable periods S using the truck of the truck type 701, and in the determination process, the transported item count 503 of the product of the given item 401 in the front-loading period T and the given front-loadable period S are determined on the basis of the degree of priority for each of the front-loadable periods S calculated in the calculation process.

As a result, for a front-loading period T of August and a product X, for example, the transportation plan generation apparatus 200 calculates the front-loading priorities p_{X84}, p_{X86}, and p_{X87} for each of the front-loadable periods S of April, June, and July, and selects the front-loading priority p_{Y86} of 1000, which is the maximum value among the front-loading priorities p_{X84}, p_{X86}, and p_{X87}. Thus, the transportation plan generation apparatus 200 can generate a transportation plan with the least expense among the front-loadable periods S of April, June, and July of front-loading the transported item count 503 of the front-loading period T of August for the product Y to the front-loadable period S of June.

(4) In (1), the transportation plan generation apparatus 200 is configured to execute a calculation process of calculating, for each combination (i,s) of the product of the item 401 and the front-loadable periods S, the front-loading priority pᵢₜₛ at which the portion of the transportation volume of the front-loading period T is reallocated from the front-loading period T to the front-loadable periods S, on the basis of a first transport truck unit cost for transporting the product of the item 401 of the front-loading period T during the front-loading period T using the truck of the truck type 701, and a second transport truck unit cost for transporting the product of the item 401 during the front-loadable periods S using the truck of the truck type 701, and in the determination process, the transported item count 503 of the product of the given item 401 of the front-loading period T and the given front-loadable period S are determined on the basis of the front-loading priority pᵢₜₛ for each combination (i,s) calculated in the calculation process.

As a result, for a front-loading period T of August, for example, the transportation plan generation apparatus 200 calculates the front-loading priorities p_{X84}, p_{X86}, p_{X87}, p_{Y84}, p_{Y86}, p_{Y87}, p_{Z84}, p_{Z86}, and p_{Z87} for each combination (i, s) of the products X, Y, Z and the front-loadable periods S of April, June, and July, and selects the front-loading priority p_{X86} of 1500, which is the maximum value among the front-loading priorities p_{X84}, p_{X86}, p_{X87}, p_{Y84}, p_{Y86}, p_{Y87}, p_{Z84}, p_{Z86}, and p_{Z87}. Thus, the transportation plan generation apparatus 200 can generate a transportation plan with the least expense among the combination (i,s) of the products X, Y, and Z and the front-loadable periods S of April, June, and July of front-loading the transported item count 503 of the front-loading period T of August for the product X to the front-loadable period S of June.

(5) In (1), the transportation plan generation apparatus 200 can access a storage fee information DB 313 that defines an inventory unit cost 602 that is the storage fee for the item 401, is configured to execute a calculation process of calculating, for each product of the item 401, the front-loading priority pᵢₜₛ at which the portion of the transportation volume of the front-loading period T is reallocated from the front-loading period T to the front-loadable periods S, on the basis of an increase amount C^{S}ᵢ(t−s) for the inventory unit cost 602 for storing the product of the item 401 in the front-loading period T from the front-loadable period S to the front-loading period T, and in the determination process, the transported item count 503 of the product of the given item 401 in the front-loading period T and the given front-loadable period S are determined on the basis of the front-loading priority pᵢₜₛ for each of the products of the item 401 calculated in the calculation process.

As a result, for a front-loading period T of August and a front-loadable period S of April, for example, the transportation plan generation apparatus 200 calculates the front-loading priorities p_{X84}, p_{Y84}, and p_{Z84} for each product X, Y, and Z, and the front-loading priority p_{X84} of 100, which is the maximum value among the front-loading priorities p_{X84}, p_{Y84}, and p_{Z84}, is selected. Thus, the transportation plan generation apparatus 200 can generate a transportation plan with the least expense among the products X, Y, and Z, with consideration for the storage fee, of front-loading the transported item count 503 of the front-loading period T of August for the product X to the front-loadable period S of April.

(6) In (1), the transportation plan generation apparatus 200 can access a storage fee information DB 313 that defines an inventory unit cost 602 that is the storage fee for the item 401, is configured to execute a calculation process of calculating, for each front-loadable period S, the front-loading priority pᵢₜₛ at which the portion of the transportation volume of the front-loading period T is reallocated from the front-loading period T to the front-loadable periods S, on the basis of an increase amount C^{S}ᵢ(t−s) for the storage fee for storing the product of the item 401 in the front-loading period T from the front-loadable period S to the front-loading period T, and in the determination process, the processor is configured to determine the transported item count 503 of the product of the given item 401 in the front-loading period T and the given front-loadable period S on the basis of the front-loading priority pᵢₜₛ for each of the front-loadable periods S calculated in the calculation process.

As a result, for a front-loading period T of August and a product X, for example, the transportation plan generation apparatus 200 calculates the front-loading priorities p_{X84}, p_{X86}, and p_{X87} for each of the front-loadable periods S of April, June, and July, and selects the front-loading priority p_{Y86} of 1000, which is the maximum value among the front-loading priorities p_{X84}, p_{X86}, and p_{X87}. Thus, the transportation plan generation apparatus 200 can generate a transportation plan with the least expense, with consideration for the storage fee, among the front-loadable periods S of April, June, and July of front-loading the transported item count 503 of the front-loading period T of August for the product Y to the front-loadable period S of June.

(7) In (1), the transportation plan generation apparatus 200 can access a storage fee information DB 313 that defines an inventory unit cost 602 that is the storage fee for the item 401, is configured to execute a calculation process of calculating, for each combination (i, s) of the product of item 401 and the front-loadable period S, the front-loading priority pᵢₜₛ at which the portion of the transportation volume of the front-loading period T is reallocated from the front-loading period T to the front-loadable periods S, on the basis of an increase amount C^{S}ᵢ(t−s) for the storage fee for storing the product of the item 401 in the front-loading period T from the front-loadable period S to the front-loading period T, and in the determination process, the transported item count 503 of the product of the given item 401 of the front-loading period T and the given front-loadable period S are determined on the basis of the front-loading priority pᵢₜₛ for each combination (i,s) calculated in the calculation process.

As a result, for a front-loading period T of August, for example, the transportation plan generation apparatus 200 calculates the front-loading priorities p_{X84}, p_{X86}, p_{X87}, p_{Y84}, p_{Y86}, p_{Y87}, p_{Z84}, p_{Z86}, and p_{Z87} for each combination (i, s) of the products X, Y, Z and the front-loadable periods S of April, June, and July, and selects the front-loading priority p_{X86} of 1500, which is the maximum value among the front-loading priorities p_{X84}, p_{X86}, p_{X87}, p_{Y84}, p_{Y86}, p_{Y87}, p_{Z84}, p_{Z86}, and p_{Z87}. Thus, the transportation plan generation apparatus 200 can generate a transportation plan with the least expense, with consideration for the storage fee, among the combination (i,s) of the products X, Y, and Z and the front-loadable periods S of April, June, and July of front-loading the transported item count 503 of the front-loading period T of August for the product X to the front-loadable period S of June.

(8) In (1), the transportation plan generation apparatus 200 is configured to execute a calculation process of calculating, for each product of the item 401, the front-loading priority pᵢₜₛ at which the portion of the transportation volume of the front-loading period T is reallocated from the front-loading period T to the front-loadable periods S, on the basis of the transported item count 503 of the product of the item 401 in the front-loading period T, and in the determination process, the transported item count 503 of the product of the given item 401 in the front-loading period T and the given front-loadable period S are determined on the basis of the front-loading priority pᵢₜₛ for each of the products of the item 401 calculated in the calculation process.

As a result, for a front-loading period T of August and a front-loadable period S of April, for example, the transportation plan generation apparatus 200 calculates the front-loading priorities p_{X84}, p_{Y84}, and p_{Z84} for each product X, Y, and Z, and the front-loading priority p_{X84} of 100, which is the maximum value among the front-loading priorities p_{X84}, p_{Y84}, and p_{Z84}, is selected. Thus, the transportation plan generation apparatus 200 can generate a transportation plan with the least expense among the products X, Y, and Z, with consideration for the maximum front-loadable count, of front-loading the transported item count 503 of the front-loading period T of August for the product X to the front-loadable period S of April.

(9) In (1), the transportation plan generation apparatus 200 is configured to execute a calculation process of calculating, for each front-loadable period S, the front-loading priority pᵢₜₛ at which the portion of the transportation volume of the front-loading period T is reallocated from the front-loading period T to the front-loadable periods S, on the basis of the transported item count 503 of the product of the item 401 in the front-loading period T, and in the determination process, the transported item count 503 of the product of the given item 401 in the front-loading period T and the given front-loadable period S are determined on the basis of the front-loading priority pᵢₜₛ for each of the front-loadable periods S calculated in the calculation process.

As a result, for a front-loading period T of August and a product X, for example, the transportation plan generation apparatus 200 is configured to calculate the front-loading priorities p_{X84}, p_{X86}, and p_{X87} for each of the front-loadable periods S of April, June, and July, and selects the front-loading priority p_{Y86} of 1000, which is the maximum value among the front-loading priorities p_{X84}, p_{X86}, and p_{X87}. Thus, the transportation plan generation apparatus 200 can generate a transportation plan with the least expense, with consideration for the maximum front-loadable count, among the front-loadable periods S of April, June, and July of front-loading the transported item count 503 of the front-loading period T of August for the product Y to the front-loadable period S of June.

(10) In (1), the transportation plan generation apparatus 200 is configured to execute a calculation process of calculating, for each combination (i, s) of the product of the item 401 and the front-loadable period S, the front-loading priority pᵢₜₛ at which the portion of the transportation volume of the front-loading period T is reallocated from the front-loading period T to the front-loadable periods S, on the basis of the transported item count 503 of the product of the item 401 in the front-loading period T, and in the determination process, the transported item count 503 of the product of the given item 401 in the front-loading period T and the given front-loadable period S are determined on the basis of the front-loading priority pᵢₜₛ for each of the products of the item 401 calculated in the calculation process.

As a result, for a front-loading period T of August, for example, the transportation plan generation apparatus 200 calculates the front-loading priorities p_{X84}, p_{X86}, p_{X87}, p_{Y84}, p_{Y86}, p_{Y87}, p_{Z84}, p_{Z86}, and p_{Z87} for each combination (i, s) of the products X, Y, Z and the front-loadable periods S of April, June, and July, and selects the front-loading priority p_{X86} of 1500, which is the maximum value among the front-loading priorities p_{X84}, p_{X86}, p_{X87}, p_{Y84}, p_{Y86}, p_{Y87}, p_{Z84}, p_{Z86}, and p_{Z87}. Thus, the transportation plan generation apparatus 200 can generate a transportation plan with the least expense, with consideration for the maximum front-loadable count, among the combination (i,s) of the products X, Y, and Z and the front-loadable periods S of April, June, and July of front-loading the transported item count 503 of the front-loading period T of August for the product X to the front-loadable period S of June.

(11) In (1), the transportation plan generation apparatus 200 is configured to execute a calculation process of calculating, for each product of the item 401, the front-loading priority pᵢₜₛ at which the portion of the transportation volume of the front-loading period T is reallocated from the front-loading period T to the front-loadable periods S, on the basis of the maximum transported item count ((Eₛ−eₛ)/vᵢ) of the product of the item 401 in the front-loading period T that can be front-loaded to the front-loadable period S, and in the determination process, the transported item count 503 of the product of the given item 401 in the front-loading period T and the given front-loadable period S are determined on the basis of the front-loading priority pᵢₜₛ for each of the products of the item 401 calculated in the calculation process.

As a result, for a front-loading period T of August and a front-loadable period S of April, for example, the transportation plan generation apparatus 200 calculates the front-loading priorities p_{X84}, p_{Y84}, and p_{Z84} for each product X, Y, and Z, and the front-loading priority p_{X84} of 100, which is the maximum value among the front-loading priorities p_{X84}, p_{Y84}, and p_{Z84}, is selected. Thus, the transportation plan generation apparatus 200 can generate a transportation plan with the least expense, with consideration for the maximum additionally transportable item count within the transportation capability for the products X, Y, and Z, of front-loading the transported item count 503 of the front-loading period T of August for the product X to the front-loadable period S of April.

(12) In (1), the transportation plan generation apparatus 200 executes a calculation process of calculating, for each front-loadable period S, the front-loading priority pᵢₜₛ at which the portion of the transportation volume of the front-loading period T is reallocated from the front-loading period T to the front-loadable periods S, on the basis of the maximum transported item count ((Eₛ−eₛ)/vᵢ) of the product of the item 401 in the front-loading period T that can be front-loaded to the front-loadable period S, and in the determination process, the transported item count 503 of the product of the given item 401 in the front-loading period T and the given front-loadable period S are determined on the basis of the front-loading priority pᵢₜₛ for each of the front-loadable periods S calculated in the calculation process.

As a result, for a front-loading period T of August and a product X, for example, the transportation plan generation apparatus 200 calculates the front-loading priorities p_{X84}, p_{X86}, and p_{X87} for each of the front-loadable periods S of April, June, and July, and selects the front-loading priority p_{Y86} of 1000, which is the maximum value among the front-loading priorities p_{X84}, p_{X86}, and p_{X87}. Thus, the transportation plan generation apparatus 200 can generate a transportation plan with the least expense, with consideration for the maximum additionally transportable item count within the transportation capability for the front-loadable periods S of April, June, and July, of front-loading the transported item count 503 of the front-loading period T of August for the product Y to the front-loadable period S of June.

(13) In (1), the transportation plan generation apparatus 200 is configured to execute a calculation process of calculating, for each combination (i, s) of the product of the item 401 and the front-loadable period S, the front-loading priority pᵢₜₛ at which the portion of the transportation volume of the front-loading period T is reallocated from the front-loading period T to the front-loadable periods S, on the basis of the maximum transported item count ((Eₛ−eₛ)/vᵢ) of the product of the item 401 in the front-loading period T that can be front-loaded to the front-loadable period S, and in the determination process, the transported item count 503 of the product of the given item 401 in the front-loading period T and the given front-loadable period S are determined on the basis of the front-loading priority pᵢₜₛ for each of the products of the item 401 calculated in the calculation process.

As a result, for a front-loading period T of August, for example, the transportation plan generation apparatus 200 calculates the front-loading priorities p_{X84}, p_{X86}, p_{X87}, p_{Y84}, p_{Y86}, p_{Y87}, p_{Z84}, p_{Z86}, and p_{Z87} for each combination (i, s) of the products X, Y, Z and the front-loadable periods S of April, June, and July, and selects the front-loading priority p_{X86} of 1500, which is the maximum value among the front-loading priorities p_{X84}, p_{X86}, p_{X87}, p_{Y84}, p_{Y86}, p_{Y87}, p_{Z84}, p_{Z86}, and p_{Z87}. Thus, the transportation plan generation apparatus 200 can generate a transportation plan with the least expense, with consideration for the maximum additionally transportable item count within the transportation capability, among the combination (i,s) of the products X, Y, and Z and the front-loadable periods S of April, June, and July, of front-loading the transported item count 503 of the front-loading period T of August for the product X to the front-loadable period S of June.

(14) In (1), the transportation plan generation apparatus 200 is configured to executes a calculation process of calculating, for each product of the item 401, the front-loading priority pᵢₜₛ at which the portion of the transportation volume of the front-loading period T is reallocated from the front-loading period T to the front-loadable periods S, on the basis of the lesser of the transported item count 503 of the product of the item 401 in the front-loading period T and the maximum transported item count ((Eₛ−eₛ)/vᵢ) of the product of the item 401 in the front-loading period T that can be front-loaded to the front-loadable period S, and in the determination process, the transported item count 503 of the product of the given item 401 in the front-loading period T and the given front-loadable period S are determined on the basis of the front-loading priority pᵢₜₛ for each of the products of the item 401 calculated in the calculation process.

As a result, for a front-loading period T of August and a front-loadable period S of April, for example, the transportation plan generation apparatus 200 calculates the front-loading priorities p_{X84}, p_{Y84}, and p_{Z84} for each product X, Y, and Z, and the front-loading priority p_{X84} of 100, which is the maximum value among the front-loading priorities p_{X84}, p_{Y84}, and p_{Z84}, is selected. Thus, the transportation plan generation apparatus 200 can generate a transportation plan with the least expense among the products X, Y, and Z, with consideration for the maximum front-loadable count rᵢₜₛ, of front-loading the transported item count 503 of the front-loading period T of August for the product X to the front-loadable period S of April.

(15) In (1), the transportation plan generation apparatus 200 is configured to execute a calculation process of calculating, for each front-loadable period S, the front-loading priority pᵢₜₛ at which the portion of the transportation volume of the front-loading period T is reallocated from the front-loading period T to the front-loadable periods S, on the basis of the lesser of the transported item count 503 of the product of the item 401 in the front-loading period T and the maximum transported item count ((Eₛ−eₛ)/vᵢ) of the product of the item 401 in the front-loading period T that can be front-loaded to the front-loadable period S, and in the determination process, the transported item count 503 of the product of the given item 401 in the front-loading period T and the given front-loadable period S are determined on the basis of the front-loading priority pᵢₜₛ for each of the front-loadable periods S calculated in the calculation process.

As a result, for a front-loading period T of August and a product X, for example, the transportation plan generation apparatus 200 calculates the front-loading priorities p_{X84}, p_{X86}, and p_{X87} for each of the front-loadable periods S of April, June, and July, and selects the front-loading priority p_{Y86} of 1000, which is the maximum value among the front-loading priorities p_{X84}, p_{X86}, and p_{X87}. Thus, the transportation plan generation apparatus 200 can generate a transportation plan with the least expense, with consideration for the maximum front-loadable count rᵢₜₛ, among the front-loadable periods S of April, June, and July, of front-loading the transported item count 503 of the front-loading period T of August for the product Y to the front-loadable period S of June.

(16) In (1), the transportation plan generation apparatus 200 is configured to execute a calculation process of calculating, for each combination (i,s) of the product of the item 401 and the front-loadable period S, the front-loading priority pᵢₜₛ at which the portion of the transportation volume of the front-loading period T is reallocated from the front-loading period T to the front-loadable periods S, on the basis of the lesser of the transported item count 503 of the product of the item 401 in the front-loading period T and the maximum transported item count ((Eₛ−eₛ)/vᵢ) of the product of the item 401 in the front-loading period T that can be front-loaded to the front-loadable period S, and in the determination process, the transported item count 503 of the product of the given item 401 in the front-loading period T and the given front-loadable period S are determined on the basis of the front-loading priority pᵢₜₛ for each of the products of the item 401 calculated in the calculation process.

As a result, for a front-loading period T of August, for example, the transportation plan generation apparatus 200 calculates the front-loading priorities p_{X84}, p_{X86}, p_{X87}, p_{Y84}, p_{Y86}, p_{Y87}, p_{Z84}, p_{Z86}, and p_{Z87} for each combination (i, s) of the products X, Y, Z and the front-loadable periods S of April, June, and July, and selects the front-loading priority p_{X86} of 1500, which is the maximum value among the front-loading priorities p_{X84}, p_{X86}, p_{X87}, p_{Y84}, p_{Y86}, p_{Y87}, p_{Z84}, p_{Z86}, and p_{Z87}. Thus, the transportation plan generation apparatus 200 can generate a transportation plan with the least expense, with consideration for the maximum front-loadable count rᵢₜₛ, among the combination (i,s) of the products X, Y, and Z and the front-loadable periods S of April, June, and July, of front-loading the transported item count 503 of the front-loading period T of August for the product X to the front-loadable period S of June.

(17) In (1), the transportation plan generation apparatus 200 is configured to execute: a learning process of generating a learning model on the basis of performance data 1810 having, as an objective variable, an actual truck count 1902 for trucks of the truck type 701 in a past period, and having, as an explanatory variable, at least one of a holiday/weekend day count 1904 of the past period, an accounting period flag 1905 indicating whether the past period is an accounting period, and a consecutive holiday flag 1906 indicating whether the past period includes consecutive holidays; and a prediction process of inputting, to the learning model generated in the learning process, prediction data 1820 that is the explanatory variable in a prediction period, to output the predicted truck count 2102 for trucks of the truck type 701 in the prediction period, and in the detection process, the front-loading period T, among the prediction period, during which the transportation volume for each period based on the predicted truck count 2102 for the truck of the truck type 701 and the volume 402 exceeds the transport capacity TC is detected.

Thus, by predicting the predicted truck count 2102 from past performance data, it is possible to improve detection accuracy of the front-loading period T.

(18) In (1), the transportation plan generation apparatus 200 is configured to execute an update process of updating the transported item count information DB 312 on the basis of a determination result of the determination process, and output the update results from the update process during the output process.

As a result, it is possible to construct a transported item count information DB 312 that takes front-loading into consideration. (19) In (18), the transportation plan generation apparatus 200 is configured to determine, in the update process, whether the transportation volume of the front-loading period T is less than or equal to the transport capacity TC by updating the transported item count information DB 312, and execute again the identification process and the determination process on the basis the update result if the transportation volume of the front-loading period T is not less than or equal to the transport capacity TC.

As a result, the identification process and the determination process are executed until the transportation volume of the front-loading period T is less than or equal to the transport capacity TC, thereby enabling optimization of the front-loading.

(20) In (2), in the transportation plan generation apparatus 200, the product information DB 311 is associated with the maximum storage time 403 for the item 401, and in the calculation process, the front-loading priority pᵢₜₛ is calculated on the basis of the maximum storage time 403 for the item 401.

As a result, the transportation plan generation apparatus 200 does not calculate the front-loading priority pᵢₜₛ for front-loadable periods S that are prior to the maximum storage time before the date 501. Thus, the transportation plan generation apparatus 200 can perform front-loading such that the product has value at the time of the date 501.

(21) In (2), the transportation plan generation apparatus 200 is configured to calculate, for each transported item, the front-loading priority pᵢₜₛ on the basis of a fluctuation model in which the value of the product of the item 401 fluctuates between the front-loading period T and the front-loadable period S.

As a result, the transportation plan generation apparatus 200 can calculate the front-loading priority pᵢₜₛ with consideration for the fluctuating product value.

It should be noted that this disclosure is not limited to the above-mentioned embodiments, and encompasses various modification examples and the equivalent configurations within the scope of the appended claims without departing from the gist of this disclosure. For example, the above-mentioned embodiments are described in detail for a better understanding of this disclosure, and this disclosure is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. A transportation plan generation apparatus, comprising:
a processor configured to execute a program; and
a storage device configured to store the program,
wherein the processor can access transported item count information that stores a transportation date, a transported item, and a transported item count in association with each other, transported item information that stores the transported item and a volume in association with each other, and transportation fee information that stores a transportation means, a load volume, a fee for each period in association with each other, and
wherein the processor is configured to execute:
a detection process of detecting a first period, among a plurality of periods, during which the transportation volume for each period based on the transported item count and the volume exceeds a threshold;
an identification process of identifying second periods that are prior to the first period detected by the detection process, and that do not correspond to the first period;
a determination process of determining a given second period during which the fee for the transportation means is less expensive than for the first period, among the second periods identified in the identification process, to be a period to which a portion of the transportation volume of the first period is reallocated; and
an output process of outputting a determination result from the determination process.

2. The transportation plan generation apparatus according to claim 1,
wherein the processor is configured to execute a calculation process of calculating, for each of the transported items, a degree of priority at which the portion of the transportation volume of the first period is reallocated from the first period to the second periods, on the basis of a first fee for transporting the transported item of the first period during the first period using the transportation means, and a second fee for transporting the transported item during the second periods using the transportation means, and
wherein, in the determination process, the processor is configured to determine the transported item count of a given transported item in the first period and the given second period on the basis of the degree of priority for each of the transported items calculated in the calculation process.

3. The transportation plan generation apparatus according to claim 1,
wherein the processor is configured to execute a calculation process of calculating, for each of the second periods, a degree of priority at which the portion of the transportation volume of the first period is reallocated from the first period to the second periods, on the basis of a first fee for transporting the transported item of the first period during the first period using the transportation means, and a second fee for transporting the transported item during the second periods using the transportation means, and
wherein, in the determination process, the processor is configured to determine the transported item count of a given transported item in the first period and the given second period on the basis of the degree of priority for each of the second periods calculated in the calculation process.

4. The transportation plan generation apparatus according to claim 1,
wherein the processor is configured to execute a calculation process of calculating, for each combination of the transported item and the second periods, a degree of priority at which the portion of the transportation volume of the first period is reallocated from the first period to the second periods, on the basis of a first fee for transporting the transported item of the first period during the first period using the transportation means, and a second fee for transporting the transported item during the second periods using the transportation means, and
wherein, in the determination process, the processor is configured to determine the transported item count of a given transported item in the first period and the given second period on the basis of the degree of priority for each of the combinations calculated in the calculation process.

5. The transportation plan generation apparatus according to claim 1,
wherein the processor can access storage fee information that defines a storage fee for the transported item,
wherein the processor is configured to execute a calculation process of calculating, for each of the transported items, a degree of priority at which the portion of the transportation volume of the first period is reallocated from the first period to the second periods, on the basis of an increase amount of the storage fee for storage of the transported item of the first period from the second period to the first period, and
wherein, in the determination process, the processor is configured to determines the transported item count of a given transported item in the first period and the given second period on the basis of the degree of priority for each of the transported items calculated in the calculation process.

6. The transportation plan generation apparatus according to claim 1,
wherein the processor can access storage fee information that defines a storage fee for the transported item,
wherein the processor is configured to execute a calculation process of calculating, for each of the second periods, a degree of priority at which the portion of the transportation volume of the first period is reallocated from the first period to the second periods, on the basis of an increase amount of the storage fee for storage of the transported item of the first period from the second period to the first period, and
wherein, in the determination process, the processor is configured to determine the transported item count of a given transported item in the first period and the given second period on the basis of the degree of priority for each of the second periods calculated in the calculation process.

7. The transportation plan generation apparatus according to claim 1,
wherein the processor can access storage fee information that defines a storage fee for the transported item,
wherein the processor is configured to execute a calculation process of calculating, for each combination of the transported item and the second periods, a degree of priority at which the portion of the transportation volume of the first period is reallocated from the first period to the second periods, on the basis of an increase amount in a storage fee for storage of the transported item of the first period from the second period to the first period, and
wherein, in the determination process, the processor is configured to determine the transported item count of a given transported item in the first period and the given second period on the basis of the degree of priority for each of the combinations calculated in the calculation process.

8. The transportation plan generation apparatus according to claim 1,
wherein the processor is configured to execute a calculation process of calculating, for each of the transported items, a degree of priority at which the portion of the transportation volume of the first period is reallocated from the first period to the second periods, on the basis of the transported item count of the transported item in the first period, and
wherein, in the determination process, the processor is configured to determine the transported item count of a given transported item in the first period and the given second period on the basis of the degree of priority for each of the transported items calculated in the calculation process.

9. The transportation plan generation apparatus according to claim 1,
wherein the processor is configured to execute a calculation process of calculating, for each of the second periods, a degree of priority at which the portion of the transportation volume of the first period is reallocated from the first period to the second periods, on the basis of the transported item count of the transported item in the first period, and
wherein, in the determination process, the processor is configured to determine the transported item count of a given transported item in the first period and the given second period on the basis of the degree of priority for each of the second periods calculated in the calculation process.

10. The transportation plan generation apparatus according to claim 1,
wherein the processor is configured to execute:
a learning process of generating a learning model on the basis of performance data having, as an objective variable, an actual count for the transportation means in a past period, and having, as an explanatory variable, at least one of a holiday/weekend day count of the past period, information indicating whether the past period is an accounting period, and information indicating whether the past period includes consecutive holidays; and
a prediction process of inputting, to the learning model generated in the learning process, prediction data that is the explanatory variable in a prediction period, to output a predicted count for the transportation means in the prediction period, and
wherein, in the detection process, the processor detects one period, among the prediction periods, during which the transportation volume for each of the periods based on the predicted count for the transportation means and the volume exceeds a threshold.

11. The transportation plan generation apparatus according to claim 1,
wherein the processor is configured to execute an update process of updating the transported item count information on the basis of a determination result of the determination process, and
wherein, in the output process, the processor is configured to output an update result of the update process.

12. The transportation plan generation apparatus according to claim 11,
wherein, in the update process, the processor is configured to determine whether the transportation volume of the first period is less than or equal to the threshold by updating the transported item count information, and
wherein the processor is configured to execute again the identification process and the determination process on the basis of the update result if the transportation volume of the first period is not less than or equal to the threshold.

13. The transportation plan generation apparatus according to claim 2,
wherein the transported item information is associated with a maximum storage time for the transported item, and
wherein, in the calculation process, the processor is configured to calculate the degree of priority on the basis of the maximum storage time for the transported item.

14. The transportation plan generation apparatus according to claim 2,
wherein, in the calculation process, the processor is configured to calculate the degree of priority for each of the transported items on the basis of a fluctuation model in which a value of the transported item fluctuates between the first period and the second period.

15. A transportation plan generation method executed by a transportation plan generation apparatus that has a processor configured to execute a program, and a storage device configured to store the program,
wherein the processor can access transported item count information that stores a transportation date, a transported item, and a transported item count in association with each other, transported item information that stores the transported item and a volume in association with each other, and transportation fee information that stores a transportation means, a load volume, a fee for each period in association with each other, and
wherein, in the transportation plan generation method, the processor is configured to execute:
a detection process of detecting a first period, among a plurality of periods, during which the transportation volume for each period based on the transported item count and the volume exceeds a threshold;
an identification process of identifying second periods that are prior to the first period detected by the detection process, and that do not correspond to the first period;
a determination process of determining a given second period during which the fee for the transportation means is less expensive than for the first period, among the second periods identified in the identification process, to be a period to which a portion of the transportation volume of the first period is reallocated; and
an output process of outputting a determination result from the determination process.
